(19) United States
(12) Patent Application Publication
(10) Pub. No.: US 2024/0411773 A1
(43) Pub. Date: Dec. 12, 2024

(54) DATA MANAGEMENT SYSTEM, NON-TRANSITORY COMPUTER READABLE MEDIUM STORING PROGRAM, AND DATA MANAGEMENT METHOD

(71) Applicant: FUJIFILM Business Innovation Corp., Tokyo (JP)

(72) Inventor: Takuya HONDA, Kanagawa (JP)

(73) Assignee: FUJIFILM Business Innovation Corp., Tokyo (JP)

(21) Appl. No.: 18/430,599

(22) Filed: Feb. 1, 2024

(30) Foreign Application Priority Data
Jun. 12, 2023 (JP) 2023-096529
Sep. 22, 2023 (JP) 2023-159187

(51) Int. Cl. G06F 16/27

(52) U.S. Cl. CPC G06F 16/27

(57) ABSTRACT

A data management system includes a processor configured to store data including a setting item for which a parameter is settable in a first storage unit in periodic synchronization with an information processing device that is a management target, acquire a setting condition of a parameter in a setting item of data from a second storage unit in which the setting condition is stored, and in a case where the parameter of the setting item of the data stored in the first storage unit is changed, change the parameter to satisfy the setting condition acquired from the second storage unit.

### CROSS-REFERENCE TO RELATED APPLICATIONS

This application is based on and claims priority under 35 USC 119 from Japanese Patent Application No. 2023-159187 filed Sep. 22, 2023 and Japanese Patent Application No. 2023-096529 filed Jun. 12, 2023.

### BACKGROUND

### (i) Technical Field

The present disclosure relates to a data management system, a non-transitory computer readable medium storing a program, and a data management method.

### (ii) Related Art

JP2012-030449A describes an image processing device that specifies information of a combination of setting information that is approved to be processed by the image processing device from setting information included in a job ticket of job data, disapproval information including information of a combination of setting information that is not approved to be processed by the image processing device, and prescriptive information including setting information that can be processed by the image processing device, and transmits the job ticket in which the information of the combination corresponding to the disapproval information is changed to the information of the specified combination in the setting information included in the job ticket of the job data to a transmission source of the job data.

Further, JP5286240B describes an image forming device including a controller that transmits screen data and a prohibition processing program that describes prohibition processing on a setting screen to an operation panel unit, and the operation panel unit including a communication control unit that receives the screen data from the controller and the prohibition processing program, a display processing unit that causes a display device to display the setting screen based on the received screen data, and a prohibition processing unit that executes the prohibition processing on the setting on the setting screen in accordance with the prohibition processing program.

### SUMMARY

A data management system that stores data including a setting item for which a parameter is settable in a storage unit in periodic synchronization with an information processing device that is a management target, and changes the setting of the information processing device by changing the setting item of the data stored in the storage unit in a case where the setting of the information processing device is changed can be considered.

In the data setting item, there is a setting condition of the parameter for each specification of the information processing device. The data management system, an application for inputting the parameter in the data management system, the information processing device, and the like are configured not to receive the input of the parameter in a case where the parameter deviating from the setting condition is input.

Therefore, in a case where the specification of the information processing device that is the management target is changed, the change to the setting condition corresponding to a new specification is required in a plurality of places such as the data management system, the application, and the information processing device.

Aspects of non-limiting embodiments of the present disclosure relate to a data management system, a non-transitory computer readable medium storing a program, and a data management method that reduce the number of change places of the setting condition in a case where the specification of the information processing device is changed in the data management system that manages the data including the setting item in synchronization between the information processing device and the storage unit than in a case where the setting condition is changed individually for the related device and application.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a data management system including a processor configured to store data including a setting item for which a parameter is settable in a first storage unit in periodic synchronization with an information processing device that is a management target, acquire a setting condition of a parameter in a setting item of data from a second storage unit in which the setting condition is stored, and in a case where the parameter of the setting item of the data stored in the first storage unit is changed, change the parameter to satisfy the setting condition acquired from the second storage unit.

### BRIEF DESCRIPTION OF THE DRAWINGS

Exemplary embodiment(s) of the present invention will be described in detail based on the following figures, wherein:

FIG. 1 is a diagram showing a system configuration of an information processing system according to an exemplary embodiment of the present disclosure;

FIG. 2 is a diagram for describing synchronization processing executed between a cloud server and an image forming device;

FIG. 3 is a block diagram showing a hardware configuration of the cloud server according to the above-described exemplary embodiment;

FIG. 4 is a block diagram showing a functional configuration of the cloud server according to the above-described exemplary embodiment;

FIG. 5 is a diagram showing an example of a system data dictionary in the information processing system according to the above-described exemplary embodiment;

FIG. 6 is a block diagram showing a functional configuration of the information processing system according to the above-described exemplary embodiment;

FIG. 7 is a sequence diagram for describing a flow of processing at system startup in the information processing system according to the above-described exemplary embodiment;

FIG. 8 is a sequence diagram for describing a flow of processing at setting change in the information processing system according to the above-described exemplary embodiment;

FIG. 9 is a diagram showing an example of a system data dictionary in the information processing system according to a second exemplary embodiment of the present disclosure;

FIG. 10 is a sequence diagram for describing a flow of processing at system startup in the information processing system according to the second exemplary embodiment of the present disclosure; and

FIG. 11 is a sequence diagram for describing a flow of processing of displaying a state of an actual device on a form in the information processing system according to the above-described exemplary embodiment.

### DETAILED DESCRIPTION

Hereinafter, an exemplary embodiment of the present disclosure will be described in detail with reference to the accompanying drawings.

### First Exemplary Embodiment

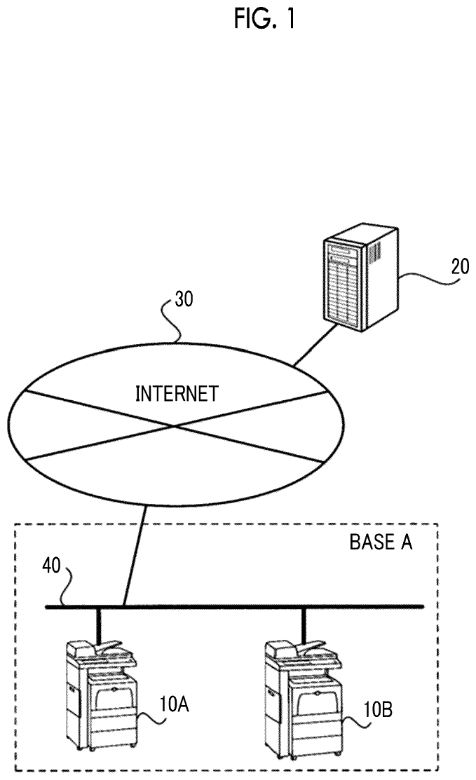

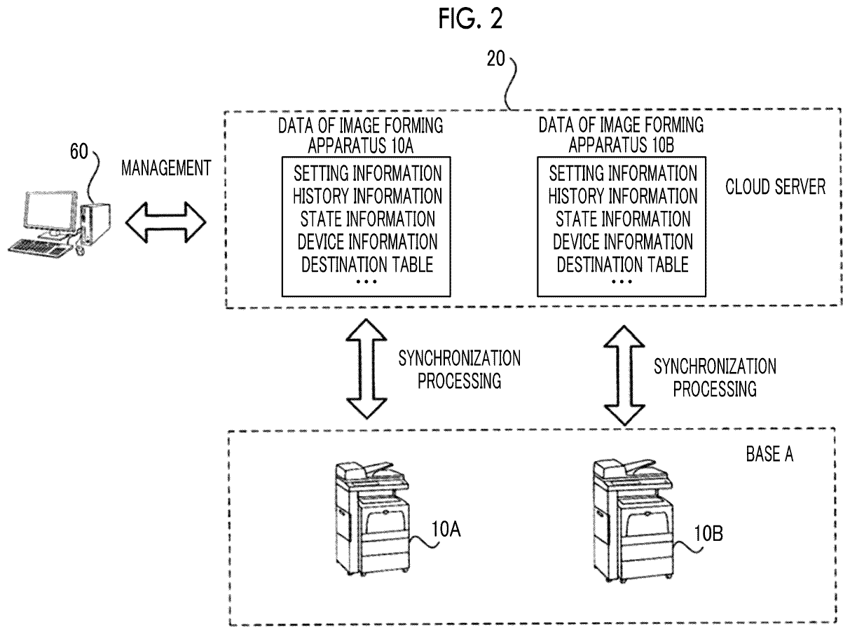

FIG. 1 is a diagram showing a system configuration of an information processing system according to a first exemplary embodiment of the present disclosure. FIG. 2 is a diagram for describing synchronization processing executed between a cloud server 20 and image forming devices 10A and 10B.

As shown in FIG. 1, the information processing system of the first exemplary embodiment of the present disclosure has a configuration in which two image forming devices 10A and 10B installed at a base A and the cloud server 20 are connected to each other via the Internet 30. The image forming devices 10A and 10B are mutually connected by a network 40 in the base A. The image forming devices 10A and 10B are so-called multifunction devices having a plurality of functions such as a printing function, a scanning function, a copying function, and a facsimile function. In the following description, in a case where the image forming devices 10A and 10B are not particularly distinguished, the image forming devices 10A and 10B are simply referred to as an image forming device 10.

As shown in FIG. 2, the cloud server 20 provides the service called digital shadow that holds various data such as setting information, history information, state information, device information, and a destination table stored in a physical device connected via the Internet 30 in synchronization with the physical device.

Specifically, the cloud server 20 stores various data such as the setting information, the history information, the state information, the device information, and the destination table of the image forming device 10 while executing the synchronization processing with the image forming device 10. The cloud server 20 is an example of a data management system according to the technique of the present disclosure.

With such a service, even in a case where a terminal device that manages a certain device cannot be directly connected to the management target device, the check of a state of the device or the management such as setting change can be executed. For example, a case where an external terminal device 60 attempts to change the setting information of the image forming device 10A will be described. First, the external terminal device 60 changes the setting information of the image forming device 10A in the cloud server 20. Then, in a case where the synchronization processing is executed with the cloud server 20, the image forming device 10A acquires updated setting information and changes the setting information of the image forming device 10A.

That is, by using such a service, even in a case where the external terminal device 60 cannot be connected to the image forming device 10 set at the base A, the check of the state of the image forming device 10, the update of the setting information, and the like can be executed.

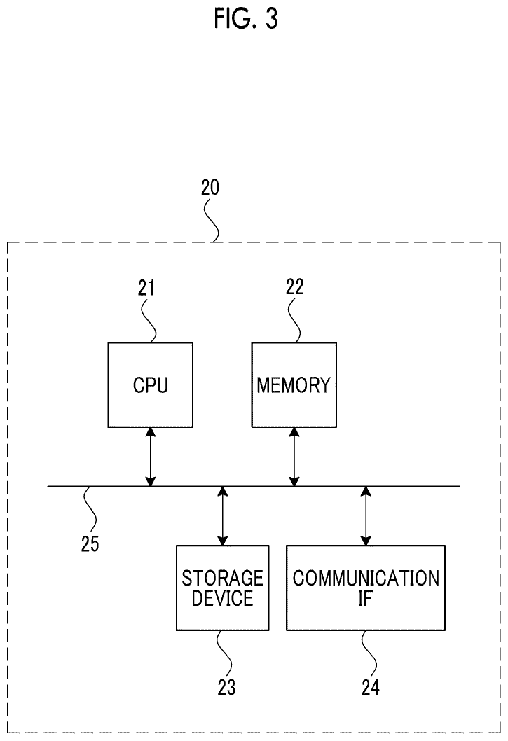

Next, the cloud server 20 will be described in detail. FIG. 3 is a block diagram showing a hardware configuration of the cloud server 20 according to the present exemplary embodiment.

As shown in FIG. 3, the cloud server 20 includes a central processing unit (CPU) 21, a memory 22, a storage device 23 such as a hard disk drive, a communication interface (hereinafter, abbreviated as IF) 24 that transmits and receives data to and from an external device, and a control bus 25. The CPU 21, the memory 22, the storage device 23, and the communication IF 24 are mutually connected via the control bus 25.

The CPU 21 is a processor that controls an operation of the cloud server 20 by executing predetermined processing based on a control program stored in the memory 22 or the storage device 23. In the present exemplary embodiment, the description has been made in which the CPU 21 reads out and executes the control program stored in the memory 22 or the storage device 23, but the present invention is not limited to this. The control program may be provided in a form recorded on a computer-readable recording medium. For example, the program may be provided in a form recorded on an optical disk such as a compact disc (CD)-read only memory (ROM) and a digital versatile disc (DVD)-ROM, or in a form recorded on a semiconductor memory such as a universal serial bus (USB) memory and a memory card. Also, the control program may be acquired from an external device via a communication line connected to the communication IF 24.

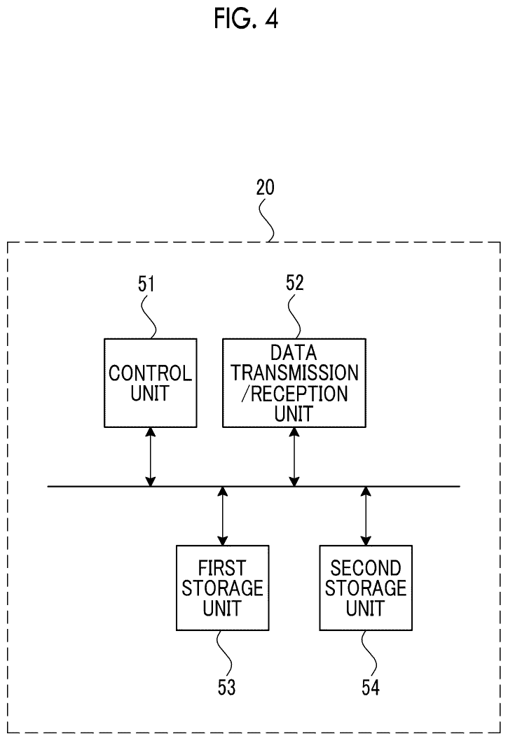

FIG. 4 is a block diagram showing a functional configuration of the cloud server 20 realized by executing the above-described control program. As shown in FIG. 4, the cloud server 20 according to the present exemplary embodiment includes a control unit 51, a data transmission/reception unit 52, a first storage unit 53, and a second storage unit 54.

The control unit 51 executes control processing of the overall operation of the cloud server 20, and provides an application for inputting parameters and the like of the setting information of the image forming device 10 to an external terminal such as the terminal device 60. In addition, the control unit 51 has a function as a framework that manages the digital shadow described later. The data transmission/reception unit 52 transmits and receives data to and from the external device.

The first storage unit 53 has a function as the digital shadow that stores various information by executing the synchronization processing with the management target device such as the image forming device 10. The second storage unit 54 has a function as a shared storage that stores a system data dictionary described later. In the following description, the first storage unit 53 may be referred to as the digital shadow, and the second storage unit 54 may be referred to as the shared storage.

In the present exemplary embodiment, both the digital shadow and the shared storage are mounted on the cloud server 20, but may be individually or commonly mounted on other devices connected to the Internet 30.

In the above-described information processing system, each setting item of the setting information includes a setting condition of the parameter for each specification of the management target device such as the image forming device 10.

The cloud server 20, an application for inputting the parameter in the cloud server 20, the management target device such as the image forming device 10, and the like are configured not to receive the input of the parameter in a case where the parameter deviating from the setting condition is input.

Therefore, in a case where the specification of the management target device such as the image forming device 10 is changed, the change to the setting condition corresponding to the new specification is required in a plurality of places such as the cloud server 20, the application, and the image forming device 10.

Therefore, in the information processing system according to the present exemplary embodiment, in a case where the specification of the management target device such as the image forming device 10 is changed by executing the control as described below, the number of places in which the setting conditions are changed may be reduced as compared with a case where the setting conditions are changed individually for the related devices and applications. In the following description, the device such as the image forming device 10 may be referred to as an actual device.

That is, the control unit 51 stores data including the setting item for which the parameter is settable in the digital shadow in periodic synchronization with the actual device, acquires the setting condition of the parameter in the setting item of the data from the shared storage in which the setting condition is stored, and in a case where the parameter of the setting item of the data stored in the digital shadow is changed, changes the parameter to satisfy the setting condition acquired from the shared storage.

Specifically, in the information processing system according to the present exemplary embodiment, the setting information is managed by using the system data dictionary (SDD) that stores the setting condition for each setting item of setting information. The system data dictionary is edited by the external device such as the terminal device 60, and is stored in the shared storage.

Basically, the system data dictionary is prepared for each model of the actual device. In a case where the versions of the control software are different even for the identical model, the system data dictionary is prepared for each version.

Note that, for example, in a case of models of the identical series, the contents of the system data dictionary may be identical. Also, even in a case where the versions of the control software are different, the contents of the system data dictionary may be identical in a case where the contents of the setting information are not changed. As described above, for the models that can use the system data dictionary in common, only one system data dictionary may be stored.

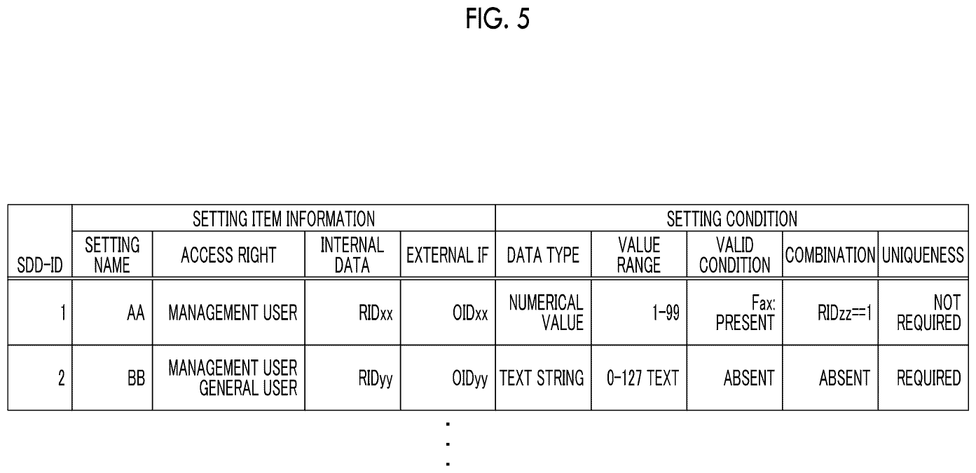

Here, the system data dictionary in the information processing system according to the present exemplary embodiment will be described. FIG. 5 is a diagram showing an example of the system data dictionary.

As shown in FIG. 5, the system data dictionary includes, for each setting item, information of “SDD-ID”, “setting name”, “access right”, “internal data”, “external interface (hereinafter abbreviated as IF)”, “data type”, “value range”, “valid condition”, “combination”, and “uniqueness”.

The “SDD-ID” is information indicating an ID given to each setting item. The “setting name” is information indicating a name of the setting item. The “access right” is information indicating a target that can access the setting item. The “internal data” is information indicating internal data of the setting item. The “external IF” is information indicating an external IF used by the setting item.

The “data type” is information indicating a data format of the setting item. The “value range” is information indicating a range of values of data that can be set in the setting item. The “valid condition” is information indicating a condition for validating the setting item. The “combination” is information indicating data used in combination with the setting item. The “uniqueness” is information indicating whether or not the uniqueness is required for the parameter of the setting item.

The information of the “setting name”, the “access right”, the “internal data”, and the “external IF” is setting item information indicating the contents of the setting item. The information of the “data type”, the “value range”, the “valid condition”, the “combination”, and the “uniqueness” is the setting condition for setting the parameter of each setting item.

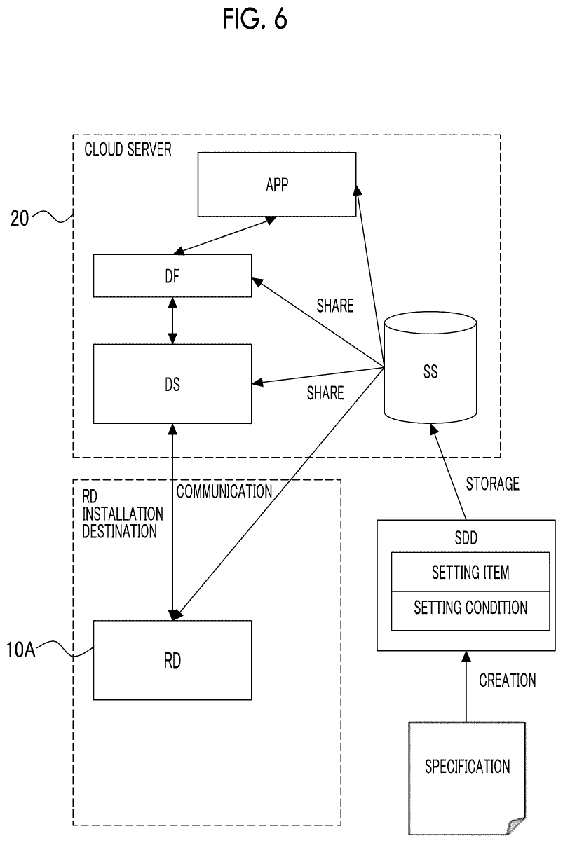

Next, a functional configuration of the information processing system according to the present exemplary embodiment will be described. FIG. 6 is a block diagram showing the functional configuration of the information processing system according to the present exemplary embodiment.

As shown in FIG. 6, the cloud server 20 has functions as a digital shadow DS, a framework DF that manages the digital shadow, and a shared storage SS. Further, the cloud server 20 provides an application APP for inputting the parameter and the like of an actual device RD.

For example, in a case where the version of the control software of the image forming device 10A is updated as the actual device RD and the specification of the setting condition for each setting item of the setting information is changed, for example, a new system data dictionary SDD is created based on a new specification by a management user or the like, and is stored in the shared storage SS.

In a case where the parameter of the setting item of the data stored in the digital shadow DS is changed, the framework DF changes the parameter to satisfy the system data dictionary SDD acquired from the shared storage SS.

In regard to the change of the parameter, in a case where the framework DF voluntarily changes the parameter, the parameter is changed within a range satisfying the setting condition included in the system data dictionary SDD.

Further, in a case where the parameter is changed based on the input of the user via the application APP, in a case where the parameter deviating from the setting condition is input, the parameter may be changed after notifying the user that the parameter deviating from the setting condition is input, prompting the user to make the correction, and causing the user to input again the parameter satisfying the setting condition.

Further, in a case where the parameter is changed based on the input of the user via the application APP, in a case where the parameter deviating from the setting condition is input, the parameter may be changed after correcting the parameter input by the user to satisfy the setting condition in the framework DF. In this case, for example, processing may be executed such as correcting an upper limit value in a case where a numerical value exceeding the upper limit value is input, correcting a full-width character to a half-width character in a case where the full-width character is input to an item that requires the half-width character input, or the like.

In a case where the parameter is changed in the information processing system, the digital shadow DS, the framework DF, the application APP, and the actual device RD commonly refer to the system data dictionary SDD of the shared storage SS, and execute the processing by using required information in the system data dictionary SDD at each of the places.

For example, the application APP causes the user to input a new parameter by using information such as the “setting name”, the “access right”, and the “value range”. In addition, the framework DF checks the accuracy of the setting information stored in the digital shadow DS by using information such as the “data type” and the “uniqueness”.

In addition, in a case where the processing of synchronizing the setting information stored in the digital shadow DS with the actual device RD is executed by the framework DF, the actual device RD checks the accuracy of the setting information stored in the actual device RD by using the information such as the “internal data”, the “external IF”, the “data type”, the “value range”, the “valid condition”, the “combination”, and the “uniqueness” in a case where the new parameter is written.

In the present exemplary embodiment, a setting value of the actual device RD, that is, the image forming device 10 is an example of the “data including the setting item for which the parameter is settable”, and the actual device RD, that is, the image forming device 10 is an example of the “information processing device that is a management target”. Further, each item stored in the system data dictionary SDD is an example of the “setting condition”. Further, the setting value of the actual device RD is an example of the “parameter”, and changing the setting value of the actual device RD is an example of “changing the parameter”.

In the cloud server 20 of the information processing system according to the present exemplary embodiment, the framework DF may newly acquire the system data dictionary SDD from the shared storage SS at startup.

In this case, the framework DF may transmit the newly acquired system data dictionary SDD or may transmit address information for accessing the newly acquired system data dictionary SDD, to at least one of the digital shadow DS, the device in which the application APP is executed (framework DF in the present exemplary embodiment), or the actual device RD.

Further, in a case where the parameter of the setting item of the data stored in the digital shadow DS is changed, the framework DF may inquire of the shared storage SS whether or not the setting item is updated since the previous acquisition, may newly acquire the setting condition from the shared storage SS in a case where the setting item is updated, and may not acquire the setting condition from the shared storage SS in a case where the setting item is not updated.

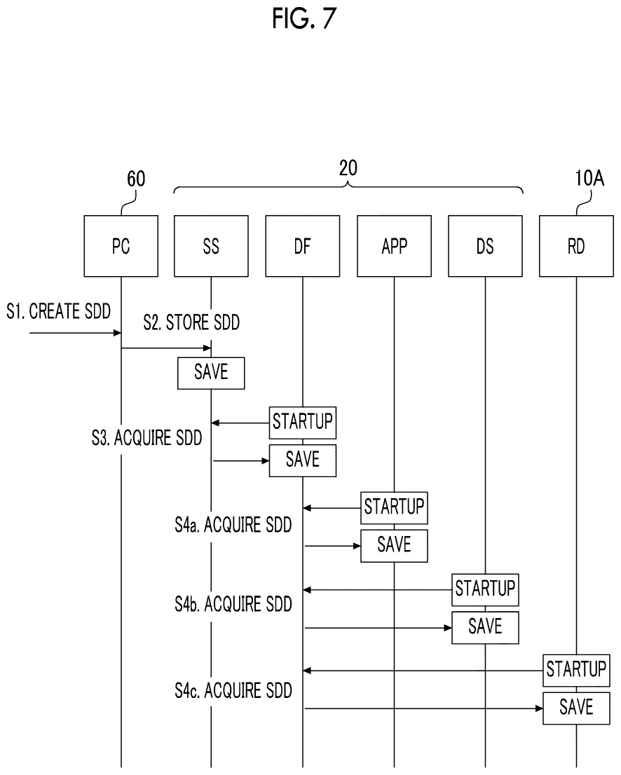

Next, a flow of processing of the information processing system according to the present exemplary embodiment will be described with reference to the sequence diagram. First, with reference to FIG. 7, a flow of the processing at system startup in the information processing system according to the present exemplary embodiment will be described.

In a case where the specification of the actual device RD managed by the framework DF is changed, as shown in FIG. 7, in step S1, for example, the user such as the management user creates the system data dictionary SDD in accordance with the new specification.

Next, in step S2, the system data dictionary SDD is transmitted to the shared storage SS from the terminal device PC in which the system data dictionary SDD is created, and is saved in the shared storage SS.

Next, in step S3, the framework DF newly acquires the system data dictionary SDD from the shared storage SS at startup, and saves the system data dictionary SDD in the framework DF.

Next, in step S4a, the application APP newly acquires the system data dictionary SDD via the framework DF at startup, and saves the system data dictionary SDD in the application APP. Further, in step S4b, the digital shadow DS newly acquires the system data dictionary SDD via the framework DF at startup, and saves the system data dictionary SDD in the digital shadow DS. Further, in step S4c, the actual device RD newly acquires the system data dictionary SDD via the framework DF at startup, and saves the system data dictionary SDD in the actual device RD.

The processing of steps S4a, S4b, and S4c is in no particular order, and the order of the processing is not limited. Further, a plurality of pieces of processing in steps S4a, S4b, and S4c may be executed simultaneously and in parallel.

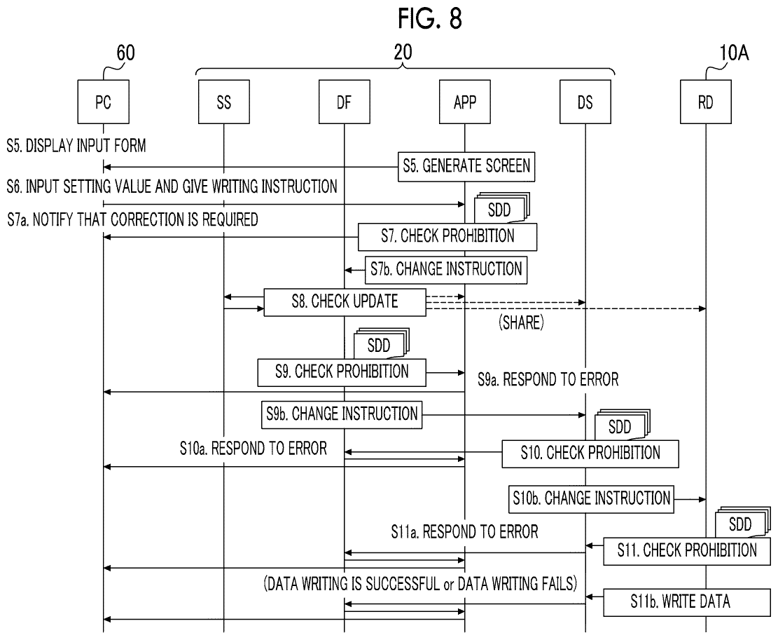

Next, with reference to FIG. 8, a flow of the processing at setting change in the information processing system according to the present exemplary embodiment will be described.

At setting change, for example, the user such as the management user starts up the application APP via the terminal device PC, and as shown in FIG. 8, in step S5, an input form for setting is displayed on the terminal device PC by the processing of the application APP.

Next, in step S6, the user inputs a new setting value in the input form of the application APP.

Next, in step S7, the application APP determines whether or not the parameter input by the user matches the setting condition, based on the system data dictionary SDD acquired in step S4a.

As a result of the determination in step S7, in a case where the parameter input by the user does not match the setting condition, in step S7a, the application APP notifies the user that the parameter input by the user does not match the setting condition, and causes the user to input the parameter again.

As a result of the determination in step S7, in a case where the parameter input by the user matches the setting condition, in step S7b, the application APP instructs the framework DF to change the parameter.

Next, in step S8, as a final check, the framework DF accesses the system data dictionary SDD saved in the shared storage SS again, and determines whether or not the parameter input by the user matches the setting condition. Thereafter, the framework DF shares the parameter input by the user with the application APP, the digital shadow DS, and the actual device RD.

Next, in step S9, the application APP determines whether or not the parameter that is input by the user and is received from the framework DF matches the setting condition, based on the system data dictionary SDD acquired in step S4a.

As a result of the determination in step S9, in a case where the parameter input by the user does not match the setting condition, in step S9a, the application APP notifies the user that the parameter input by the user does not match the setting condition, and causes the user to input the parameter again.

As a result of the determination in step S9, in a case where the parameter input by the user matches the setting condition, in step S9b, the application APP instructs the digital shadow DS to change the parameter.

Next, in step S10, the digital shadow DS determines whether or not the parameter that is input by the user and is received from the application APP matches the setting condition, based on the system data dictionary SDD acquired in step S4b.

As a result of the determination in step S10, in a case where the parameter input by the user does not match the setting condition, in step S10a, the digital shadow DS notifies the user that the parameter input by the user does not match the setting condition via the framework DF and the application APP, and causes the user to input the parameter again.

As a result of the determination in step S10, in a case where the parameter input by the user matches the setting condition, in step S10b, the digital shadow DS instructs the actual device RD to change the parameter.

Next, in step S11, the actual device RD determines whether or not the parameter that is input by the user and is received from the digital shadow DS matches the setting condition, based on the system data dictionary SDD acquired in step S4c.

As a result of the determination in step S11, in a case where the parameter input by the user does not match the setting condition, in step S11a, the actual device RD notifies the user that the parameter input by the user does not match the setting condition via the framework DF and the application APP, and causes the user to input the parameter again.

As a result of the determination in step S11, in a case where the parameter input by the user matches the setting condition, in step S11b, the actual device RD writes the data of the parameter input by the user, notifies the user the result of success or failure of data writing via the framework DF and the application APP, and terminates the processing.

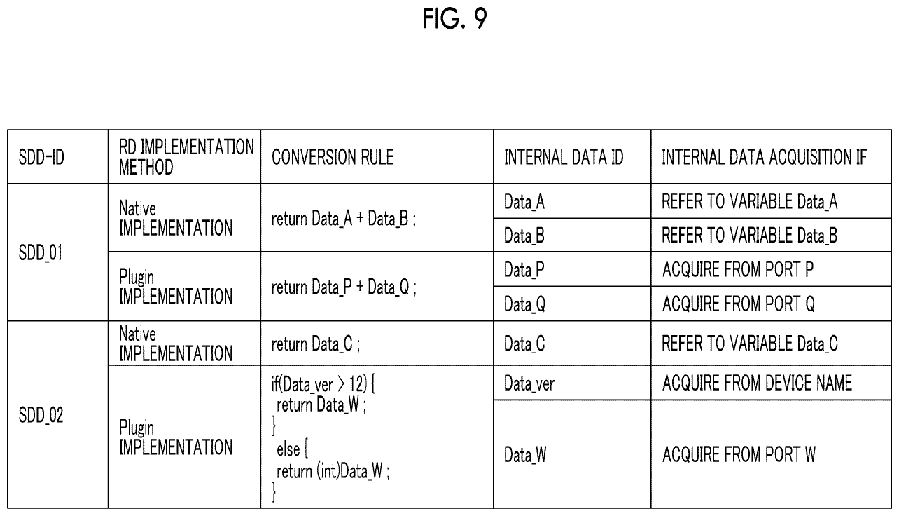

Subsequently, the information processing system according to the second exemplary embodiment of the present disclosure will be described with reference to FIGS. 9 to 11.

### Second Exemplary Embodiment

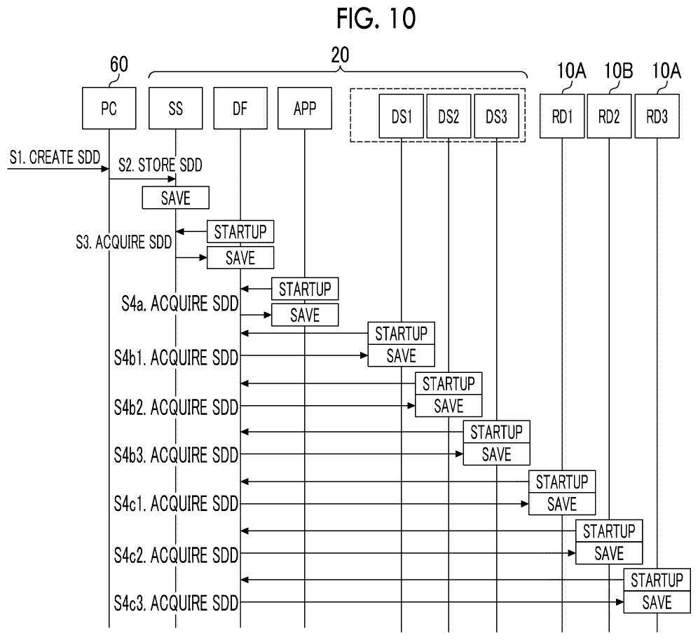

As shown in FIG. 10, the cloud server 20 of the second exemplary embodiment has a plurality of image forming devices 10 that is a management target, and has a function as a plurality of digital shadows DS corresponding to each image forming device. The plurality of image forming devices 10 have different specifications, respectively. As an example, the image forming device 10A is shipped in a state of having the communication IF 24 as a product specification. On the other hand, the image forming device 10B does not have the communication IF 24 at the time of shipment, and the communication IF 24 is attached by the user after the image forming device 10B is installed at the base A. In the description of the present exemplary embodiment, as the specification of the image forming device 10, a case where the communication IF 24 is provided at the time of shipment is referred to as a “Native implementation”, and a case where the communication IF 24 is attached by the user after shipment is referred to as a “Plugin implementation”. In FIG. 10, an actual device RD1 and an actual device RD3 are shown as the image forming device 10A, respectively, and the actual device RD1 and the actual device RD3 have the same product specification.

Other configurations according to the present exemplary embodiment are the same as the configurations according to the data management system of the first exemplary embodiment, and specific description thereof will be omitted.

FIG. 9 is a diagram showing an example of a system data dictionary SDD of a data management system according to the present exemplary embodiment. The system data dictionary SDD according to the present exemplary embodiment has items of “SDD-ID”, “RD implementation method”, “conversion rule”, “internal data ID”, and “internal data acquisition IF”.

The “RD implementation method” is information that prescribes that the image forming device 10 changes the values referred to in the “conversion rule”, the “internal data ID”, and the “internal data acquisition IF” depending on the implementation method of the communication IF 24.

For example, in FIG. 9, in a case where the communication IF 24 is provided by the “Native implementation” as in the image forming device 10A, a value of a variable “Data_C” is prescribed to be referred to and transmitted from the internal device for information of SDD-02 among the data transmitted to the digital shadow DS. More specifically, in the flow of processing of the information processing system described later, in a case where the data of the SDD-02 is requested from the digital shadow DS, the actual device RD is prescribed to refer to the value of “Data_C” from the internal device and transmit the value.

On the other hand, in a case where the communication IF 24 is provided by the “Plugin implementation” as in the image forming device 10B, a different value depending on a value of “Data_ver” is prescribed to be transmitted as the data transmitted to the digital shadow DS for the information of the SDD-02. More specifically, in the flow of processing of the information processing system described later, in a case where the data of the SDD-02 is requested from the digital shadow DS, the actual device RD is prescribed to transmit the different value depending on the value of “Data_ver”. Further, in FIG. 9, in a case where the value of “Data_ver” exceeds 12, a value acquired from an external port W is prescribed to be transmitted as a value of “Data_W”. Further, in a case where the value of “Data_ver” is equal to or less than 12, the value acquired from the external port W is prescribed to be converted into an integer type and then to be transmitted as the value of “Data_W”

Here, as described above, in the present exemplary embodiment, a different value is prescribed to be referred to and transmitted in the system data dictionary SDD depending on the specification of the image forming device 10. The implementation method of the communication IF 24 is an example of a “specification of the information processing device” in the present exemplary embodiment. Further, the prescription of changing the data to be transmitted to the digital shadow DS according to the implementation method of the communication IF 24 is an example of a “setting condition” in the present exemplary embodiment. Further, the data referred to by the actual device RD in a case of being transmitted to the digital shadow DS is an example of a “parameter” in the present exemplary embodiment. That is, changing a reference destination of the data to be transmitted to the digital shadow DS for each implementation method of the communication IF 24 of the image forming device 10 corresponds to “changing the parameter using a setting condition determined in the second storage unit for each specification of the information processing device” in the present exemplary embodiment.

In other words, the items of “RD implementation method”, “conversion rule”, and “internal data acquisition IF” in FIG. 9 are examples of “specification of information processing device”, “setting condition”, and “parameter” in the present exemplary embodiment, respectively.

The system data dictionary SDD is desirably prescribed to include, for example, all the specifications of the image forming device 10 that communicates with the cloud server 20.

The flow of processing of the information processing system of the present exemplary embodiment is the same as the flow of processing according to the first exemplary embodiment except for steps S4b and S4c in the flow of processing according to the first exemplary embodiment, as shown in the sequence diagram shown in FIG. 10. In FIG. 10, RD1, RD2, and RD3 refer to different actual devices RD, respectively, and DS1, DS2, and DS3 refer to digital shadows DS corresponding to RD1, RD2, and RD3, respectively. In the following description, in a case of distinguishing a plurality of actual devices RD and digital shadows DS, the end of the reference numerals is marked with a number of 1 to 3.

Steps S4b1, S4b2, and S4b3 according to the present exemplary embodiment correspond to step S4b according to the first exemplary embodiment. In addition, steps S4cl, S4c2, and S4c3 according to the present exemplary embodiment correspond to step S4c according to the first exemplary embodiment.

The processing of steps S4a, S4b1, S4b2, S4b3, S4c1, S4c2, and S4c3 is in no particular order, and the order of the processing is not limited. Further, a plurality of pieces of processing in steps S4a, S4b1, S4b2, S4b3, S4cl, S4c2, and S4c3 may be executed simultaneously and in parallel.

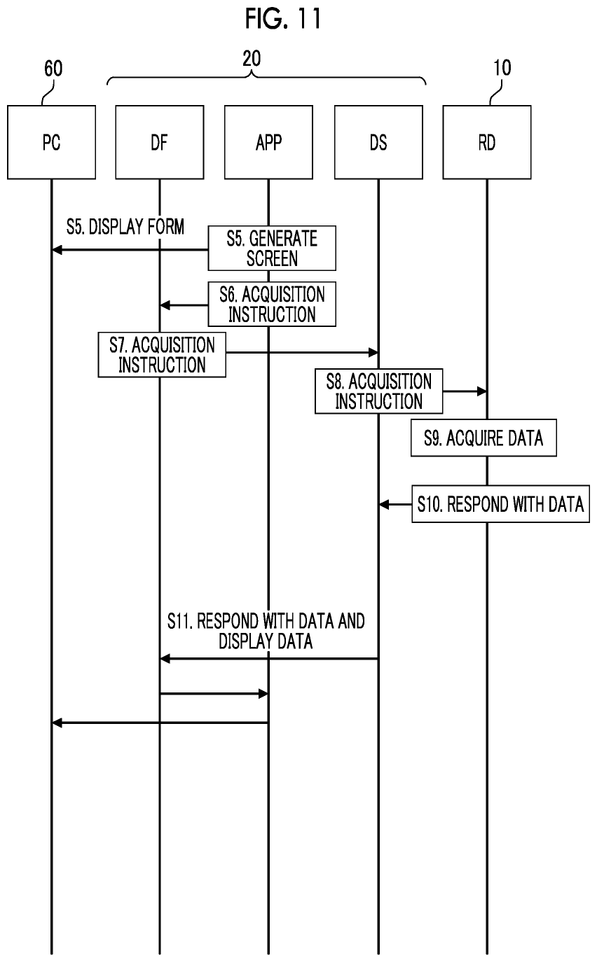

Next, a flow of processing of displaying a state of an actual device RD on a form in the information processing system according to the present exemplary embodiment with reference to FIG. 11. Since steps S1 to S4 in the present exemplary embodiment are the same as the flow of processing of the information processing system according to the first exemplary embodiment, the illustration and description thereof will be omitted. In FIG. 11, one digital shadow DS and one actual device RD are displayed, respectively, but these are any one of a plurality of digital shadows DS and any one of a plurality of actual devices RD, respectively.

For example, in a case where the user such as the management user starts up the application APP via the terminal device PC, as shown in FIG. 11, in step S5, an input form for setting is displayed on the terminal device PC by the processing of the application APP.

Next, in step S6, the application APP instructs the framework DF to acquire data from the digital shadow DS.

Next, in step S7, the framework DF supports a provision to the digital shadow DS.

Next, in step S8, the digital shadow DS requests the actual device RD for data of the SDD-ID name included in the system data dictionary SDD acquired in step S4b.

Next, in step S9, the actual device RD changes the conversion rule of the requested data of the SDD-ID name and the interface (internal data acquisition IF) for acquiring the internal data, based on the internal data ID of the system data dictionary SDD acquired in step S4c. In other words, the actual device RD changes the conversion rule and the internal data acquisition IF according to a specification of the actual device RD.

Next, in step S10, the actual device RD responds to the digital shadow DS with data according to the implementation method of the communication IF 24 as the data of the SDD-ID name acquired in step S9. In other words, the actual device RD changes a setting condition of the data acquired from the actual device RD according to the implementation method of the communication IF 24.

Next, in step S11, the digital shadow DS responds to the framework DF with the data of the SDD-ID name acquired in step S10.

The framework DF responds to the application APP with the data acquired from the digital shadow DS, and the application APP displays the data acquired from the digital shadow DS on a screen of the terminal device PC.

### Action and Effect

In the data management system of the present exemplary embodiment, the processor changes a reference destination of the data to be referred to for each specification of the image forming device 10, based on the conversion rule determined in the system data dictionary SDD.

According to the data management system of the present exemplary embodiment, even in a case where there are a plurality of image forming devices 10 that is a management target and the specifications of the image forming devices 10 are different, respectively, the number of change places of the setting condition may be reduced as compared with a case where the setting condition is changed individually.

### Modification Example

In the description of the present exemplary embodiment, both the digital shadow DS and the actual device RD acquire the system data dictionary SDD in step S4b and step S4c, but a method of acquiring data according to the present exemplary embodiment is not limited thereto. For example, the device that acquires the system data dictionary SDD may be only the digital shadows DS. That is, step S4c shown in FIG. 10 may be omitted. In this case, according to the specification of the actual device RD, the digital shadow DS transmits an instruction to the actual device RD to acquire the internal data included in the conversion rule from the interface described as the internal data acquisition IF.

### Other Exemplary Embodiments

Although the information processing system according to the exemplary embodiment of the present invention has been described above, the present invention is not limited to the above-described exemplary embodiment and can also be appropriately changed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

Hereinafter, supplementary notes of the aspects of the present disclosure will be described.

(((1)))

A data management system comprising:
a processor configured to:
   store data including a setting item for which a parameter is settable in a first storage unit in periodic synchronization with an information processing device that is a management target;
   acquire a setting condition of a parameter in a setting item of data from a second storage unit in which the setting condition is stored; and
   in a case where the parameter of the setting item of the data stored in the first storage unit is changed, change the parameter to satisfy the setting condition acquired from the second storage unit.
      (((2)))

The data management system according to (((1))), wherein the processor is configured to: newly acquire the setting condition from the second storage unit at startup.

(((3)))

The data management system according to (((2))), wherein the processor is configured to: transmit the newly acquired setting condition to at least one of the first storage unit, a device in which an application program for inputting the parameter by a user is executed, or the information processing device.

(((4)))

The data management system according to (((2))), wherein the processor is configured to: transmit address information for accessing the newly acquired setting condition to at least one of the first storage unit, a device in which an application program for inputting the parameter by a user is executed, or the information processing device.

(((5)))

The data management system according to any one of (((1))) to (((4))), wherein the processor is configured to: in a case where the parameter of the setting item of the data stored in the first storage unit is changed, inquire of the second storage unit whether or not the setting item is updated since previous acquisition and newly acquire, in a case where the setting item is updated, the setting condition from the second storage unit.

(((6)))

The data management system according to (((5))), wherein the processor is configured to: in a case where the parameter of the setting item of the data stored in the first storage unit is changed, inquire of the second storage unit whether or not the setting item is updated since previous acquisition and do not acquire, in a case where the setting item is not updated, the setting condition from the second storage unit.

(((7)))

The data management system according to any one of (((1))) to (((6))),
wherein there are a plurality of information processing devices that are a management target, and
the processor is configured to: acquire a setting condition determined for each specification of the information processing device from the second storage unit and change the parameter to satisfy the setting condition.
   (((8)))

A program for causing a computer to execute:
storing data including a setting item for which a parameter is settable in a first storage unit in periodic synchronization with an information processing device that is a management target;
acquiring a setting condition of a parameter in a setting item of data from a second storage unit in which the setting condition is stored; and
changing, in a case where the parameter of the setting item of the data stored in the first storage unit is changed, the parameter to satisfy the setting condition acquired from the second storage unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data management system comprising:
a processor configured to:
store data including a setting item for which a parameter is settable in a first storage unit in periodic synchronization with an information processing device that is a management target;
acquire a setting condition of a parameter in a setting item of data from a second storage unit in which the setting condition is stored; and
in a case where the parameter of the setting item of the data stored in the first storage unit is changed, change the parameter to satisfy the setting condition acquired from the second storage unit.

2. The data management system according to claim 1, wherein the processor is configured to:
newly acquire the setting condition from the second storage unit at startup.

3. The data management system according to claim 2, wherein the processor is configured to:
transmit the newly acquired setting condition to at least one of the first storage unit, a device in which an application program for inputting the parameter by a user is executed, or the information processing device.

4. The data management system according to claim 2, wherein the processor is configured to:
transmit address information for accessing the newly acquired setting condition to at least one of the first storage unit, a device in which an application program for inputting the parameter by a user is executed, or the information processing device.

5. The data management system according to claim 1, wherein the processor is configured to:
in a case where the parameter of the setting item of the data stored in the first storage unit is changed, inquire of the second storage unit whether or not the setting item is updated since previous acquisition and newly acquire, in a case where the setting item is updated, the setting condition from the second storage unit.

6. The data management system according to claim 5, wherein the processor is configured to:
in a case where the parameter of the setting item of the data stored in the first storage unit is changed, inquire of the second storage unit whether or not the setting item is updated since previous acquisition and do not acquire, in a case where the setting item is not updated, the setting condition from the second storage unit.

7. The data management system according to claim 1,
wherein there are a plurality of information processing devices that are a management target, and
the processor is configured to: acquire a setting condition determined for each specification of the information processing device from the second storage unit and change the parameter to satisfy the setting condition.

8. A non-transitory computer readable medium storing a program causing a computer to execute a process comprising:
storing data including a setting item for which a parameter is settable in a first storage unit in periodic synchronization with an information processing device that is a management target;
acquiring a setting condition of a parameter in a setting item of data from a second storage unit in which the setting condition is stored; and
changing, in a case where the parameter of the setting item of the data stored in the first storage unit is changed, the parameter to satisfy the setting condition acquired from the second storage unit.

9. A data management method comprising:
storing data including a setting item for which a parameter is settable in a first storage unit in periodic synchronization with an information processing device that is a management target;
acquiring a setting condition of a parameter in a setting item of data from a second storage unit in which the setting condition is stored; and
changing, in a case where the parameter of the setting item of the data stored in the first storage unit is changed, the parameter to satisfy the setting condition acquired from the second storage unit.
